(19) United States
(12) Patent Application Publication
(10) Pub. No.: US 2008/0263868 A1
(43) Pub. Date: Oct. 30, 2008

(54) Razor blade, razor head, and razor

(75) Inventor: Wan-Shun Chou, Taipei (TW)

Correspondence Address: BIRCH STEWART KOLASCH & BIRCH, PO BOX 747, FALLS CHURCH, VA, 22040-0747, US

(73) Assignee: I-CHIUN PRECISION INDUSTRY CO., LTD.

(21) Appl. No.: 11/979,055

(22) Filed: Oct. 30, 2007

(30) Foreign Application Priority Data
Apr. 27, 2007 (TW) 096114994

(51) Int. Cl. B26B 21/00

(52) U.S. Cl. 30/32

(57) ABSTRACT

The invention discloses a razor blade, a razor head, and a razor. The razor blade includes a first mounting plate, a second mounting plate, and a blade. The second mounting plate is connected to the first mounting plate, and the first mounting plate and the second mounting plate clip the blade together. The first mounting plate and the second mounting plate can be made of metal in one piece. The razor head includes the razor blade and a mounting base. The first mounting plate of the razor blade is engaged to the mounting base. The razor includes the razor blade, the mounting base, a shell, and a handle. The shell is engaged to the mounting base and the handle respectively.

### BACKGROUND OF THE INVENTION

1. Field of the Invention

The present invention relates to a razor blade and, more particularly, relates to a razor head and a razor with the razor blade.

2. Description of the Prior Art

A razor is a daily commodity for men, and the quality of the razor usually decisively depends on the quality of the razor blades therein. Moreover, the mounting method of the razor blades further affects the performance of the razor blades. In the prior art, the blades of a razor are usually directly adhered to a plastic base. The force loaded on the blades is taken directly by the blades and indirectly by the plastic base. In order to shave a beard efficiently and to clear out the beard pieces therein smoothly, the blades are usually made into sheets, while the strength of the blades is not strong. Therefore, the plastic base supports the blades with a plurality of supporting parts to provide enough structural strength. However, the strength of plastic is not as strong as that of metal. The supporting parts usually take a substantial volume to provide enough supporting strength, but it is disadvantageous to clear out beard pieces.

In addition, providing support only with the plastic supporting parts still cannot securely mount the blades. For example, when some beard is caught by the blades, the blades hooked by the hair tend to depart from the supporting parts, which might hurt the skin of a user. If clasps are designed to form on the supporting parts to hook the blades, said supporting parts may reduce or avoid the above problems. However, as described above, because the strength of the plastic-made supporting part is limited, and the design of the hook structure is restricted by the limited space, the blades can still be caught by the beard and depart. Therefore, in razors of the prior art, there are blades wound with thin metal wires to mount them on the plastic base. Though this way of mounting blades is able to efficiently mount the blades to prevent them from departing, there are disadvantageous factors of complicated processes, difficult quality control, and so on in manufacturing and assembly. Moreover, the portions of the blades contacting the thin metal wires limit their shaving functions.

Accordingly, there is a need to provide a razor blade with high strength, a razor head therewith, and a razor therewith, so as to solve the problem mentioned above.

### SUMMARY OF THE INVENTION

One scope of the invention provides a razor blade, a razor head with the razor blade, and a razor with the razor blade. The razor blade has more strength than the razor blade of the prior art.

A razor blade of the invention includes a first mounting plate, a second mounting plate connected to the first mounting plate, and a blade. The first mounting plate thereon defines a plane. The second mounting plate has a surface substantially parallel to the plane. The blade is disposed between the surface and the plane. In actual practice, the first mounting plate and the second mounting plate can be made of a metal in one piece, or the second mounting plate is connected to the first mounting plate by using a spot welding process.

In addition, the razor blade of the invention can efficiently clamp the blade by tightly pressing the blade against the first mounting plate with the second mounting plate. In actual design, the pressing can be achieved by forming an angle between the surface of the second mounting plate and the plane. That is, the second mounting plate and the first mounting plate form a barrette-like structure. Furthermore, in order to stably mount the blade between the first mounting plate and the second mounting plate, the second mounting plate can have a notch near its connection with the first mounting plate. The notch can prevent the interference to the blade caused by the fillet of the second mounting plate at the connection, so as to achieve the purpose of stably mounting the blade.

A razor head of the invention includes the first mounting plate, the second mounting plate, the blade, and a mounting base. The first mounting plate is engaged to the mounting base. In an embodiment, the first mounting plate has a first end and a second end. The first mounting plate is engaged to the mounting base through the first end and the second end. Moreover, the mounting base further includes a supporting part. The first mounting plate is disposed on the supporting part, so as to achieve the purpose of supporting the razor blade.

A razor of the invention includes the first mounting plate, the second mounting plate, the blade, the mounting base, a shell, and a handle. The shell is engaged to the mounting base and the handle respectively. In an embodiment, the handle is engaged to the shell in a detachable way. In another embodiment, the handle is engaged to the shell in a slidable or limitedly rotatable way. Therefore, according to the razor blade of the invention, it has more strength than the razor blade of the prior art. The razor blade does not need additional members, such as metal wires, to assist in mounting on the mounting base. In addition, because the strength of the razor blade is increased, the razor blade will not be caught by any beard to depart, which simplifies the structure of the mounting base. Furthermore, the blade of the razor blade of the invention can be directly formed by a press process. Moreover, the first mounting plate and the second mounting plate can also be made in one piece by a press process. Coordinating with the structurally simplified mounting base, the razor head of the invention can be easily assembled. By use of further automation, the manufacturing cost of the razor head can be lowered substantially, and the yield rate of manufacturing increases.

The advantage and spirit of the invention may be further understood by the following recitations together with the appended drawings.

### BRIEF DESCRIPTION OF THE APPENDED DRAWINGS

FIG. 1A is a front view of a razor according to a preferred embodiment.

FIG. 1B is a top view of the razor.

FIG. 1C is a right-side view of the razor.

FIG. 1D is a sketch diagram illustrating a separation state of the handle and the shell.

FIG. 1E is a sketch diagram illustrating that the handle is engaged to the shell in a limitedly rotatable way.

FIG. 2A is a front view of the first mounting plate, the second mounting plates, and the blade.

FIG. 2B is a side view of the first mounting plate, the second mounting plate, and the blade.

FIG. 2C is a sketch diagram illustrating the blade and the first mounting plate before the blade is assembled to the corresponding first mounting plate.

FIG. 2D is a front view of the second mounting plates being connected to the first mounting plate by a spot welding process.

FIG. 3A is a front view of the assembly of the mounting base and the assembly of the first mounting plates, the second mounting plates, and the blades.

FIG. 3B is a side view of the assembly of the mounting base and the assembly of the first mounting plates, the second mounting plates, and the blades.

### DETAILED DESCRIPTION OF THE INVENTION

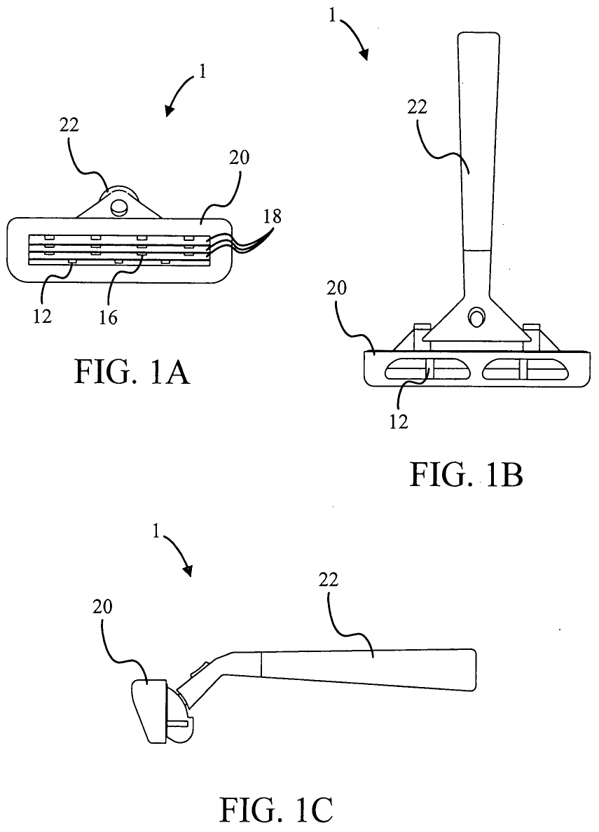

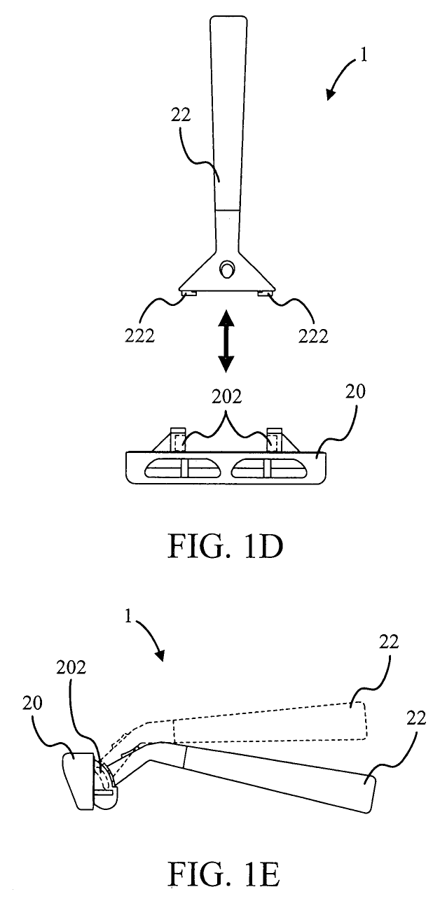

Please refer to FIG. 1A to 1C. FIG. 1A is a front view of a razor 1 according to a preferred embodiment. FIG. 1B is a top view of the razor 1. FIG. 1C is a right-side view of the razor 1. The razor 1 of the invention includes a mounting base 12, three first mounting plates 14, twelve second mounting plates 16, three blades 18, a shell 20, and a handle 22. The mounting base 12, the first mounting plates 14, the second mounting plates 16, and the blades 18 are accommodated in the shell 20. The shell 20 is engaged to the mounting base 12 and the handle 22 respectively. Each of the first mounting plates 14 corresponds to four of the second mounting plates 16 and one of the blades 18. Incidentally, in FIG. 1B, the mounting base 12, the first mounting plates 14, the second mounting plates 16, and the blades 18 can be partially seen through the hollows of the shell 20 originally. However, in order to avoid complicating the figure, the first mounting plates 14, the second mounting plates 16, and the blades 18 are skipped in FIG. 1B for the figure recognition.

Please refer to FIG. 1D and 1E. FIG. 1D is a sketch diagram illustrating a separation state of the handle 22 and the shell 20. FIG. 1E is a sketch diagram illustrating that the handle 22 is engaged to the shell 20 in a limitedly rotatable way. As shown in FIG. 1D, the shell 20 includes two slide slots 202 (shown in dashed lines in FIG. 1E), and the handle 22 includes two corresponding sliders 222. The slide slot 202 is an arc slide slot with limited length (also referring to FIG. 1E). By inserting the sliders 222 into the corresponding slide slots 202, the handle 22 can be engaged to the shell 20 in a detachable, limitedly rotatable, or slidable way. The state of the handle 22 and the shell 20 shows a rotational ability after the handle 20 is engaged to the shell 20, which is shown in FIG. 1E.

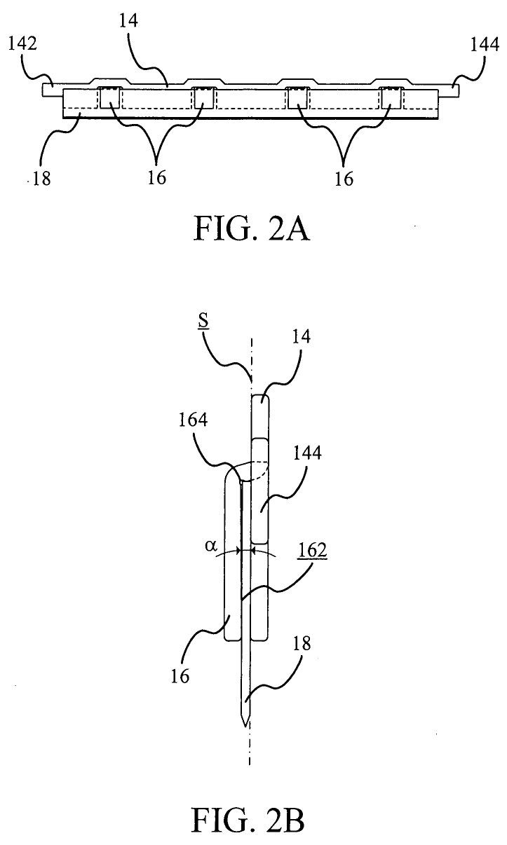

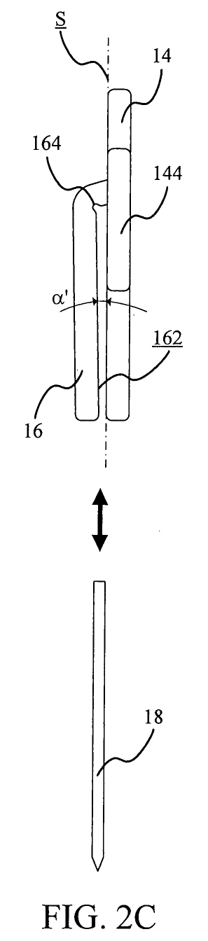

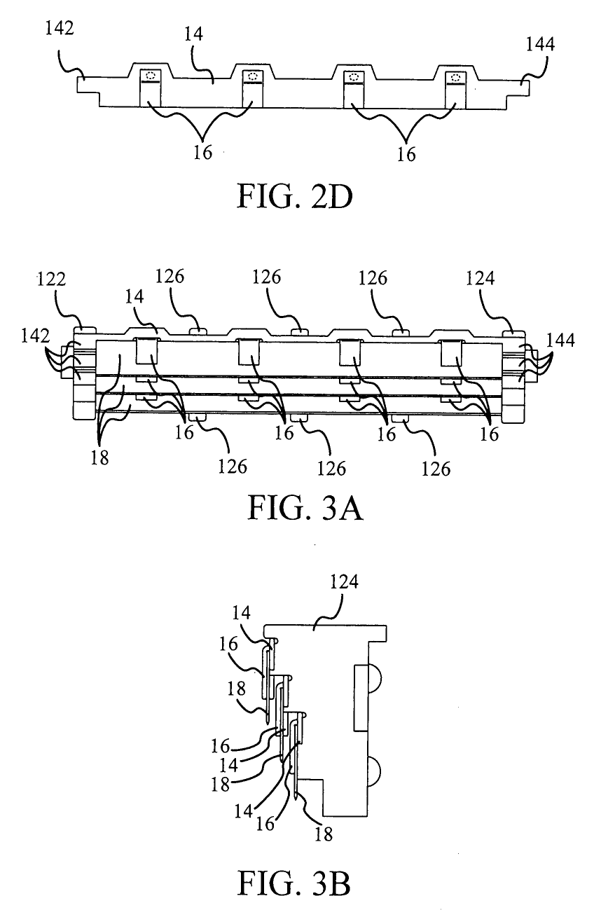

Please refer to FIGS. 2A and 2B. FIG. 2A is a front view of the first mounting plate 14, the second mounting plates 16, and the blade 18. FIG. 2B is a side view of the first mounting plate 14, the second mounting plates 16, and the blade 18. Therein, the hidden contours of the first mounting plate 14, the second mounting plates 16, and the blade 18 are shown in dashed lines. As shown in FIGS. 2A and 2B, the first mounting plate 14 is connected to the corresponding second mounting plates 16 and forms a gap therebetween, where the blade 18 is disposed. The first mounting plate 14 thereon defines a plane S. The second mounting plate 16 has a surface 162. The plane S is shown in a center line in FIG. 2B. An angle a is formed between the plane S and the surface 162 such that the first mounting plate 14 and the second mounting plate 16 form a barrette-like structure for clamping the blade 18. In an embodiment, the angle α can be designed to be about zero; that is, the surface 162 nearly sticks to the blade 18 entirely.

Please refer to FIG. 2C additionally. FIG. 2C is a sketch diagram illustrating the blade 18 and the first mounting plate 14 before the blade 18 is assembled to the corresponding first mounting plate 14 and the second mounting plates 16. The angle of view of FIG. 2C is same as that of FIG. 2B. As shown in FIG. 2C, before the blade 18 is inserted into the gap, an angle α′, larger than the angle α, is formed between the plane S and the surface 162, such that the opening width of the gap is smaller than the thickness of the blade 18. Therefore, after the blade 18 is inserted, the second mounting plates 16 can tightly press against the blade 18. That is, the first mounting plate 14 and the second mounting plates 16 can efficiently clamp the blade 18. Incidentally, in order to insert the blade 18 into the gap smoothly, the second mounting plate 16 forms a lead angle, a round, or other structure for smoothly inserting the blade 18 at the opening of the gap.

Please refer to FIGS. 2A and 2B again. The second mounting plate 16 forms a notch 164 near its connection with the first mounting plate 14. The notch 164 can keep the blade 18 from interfering with the fillet formed by the connection of the second mounting plate 16 and the first mounting plate 14, so that the blade 18 can be stably clamped in the gap.

Please refer to FIG. 2D. FIG. 2D is a front view of the second mounting plates 16 being connected to the first mounting plate 14 by a spot welding process. The angle of view of FIG. 2D is the same as that of FIG. 2A. According to the preferred embodiment, the first mounting plate 14 and the corresponding second mounting plates 16 are made of metal in one piece by a press process. However, according to the invention, the second mounting plates 16 can be mounted on the corresponding first mounting plate 14 by a spot welding process, as shown in FIG. 2D. The dashed lines in FIG. 2D represent the areas of the spot welding. Incidentally, the second mounting plates 16 in FIG. 2D are not formed by pressing the first mounting plate 14, so the first mounting plate 14 in FIG. 2D does not have cuts at the positions relative to the second mounting plates 16.

Please refer to FIGS. 3A and 3B. FIG. 3A is a front view of the assembly of the mounting base 12 and the assembly of the first mounting plates 14, the second mounting plates 16, and the blades 18. FIG. 3B is a side view of the assembly of the mounting base 12 and the assembly of the first mounting plates 14, the second mounting plates 16, and the blades 18. The first mounting plate 14 has a first end 142 and a second end 144. The mounting base 12 includes a first supporting part 122 and a second supporting part 124. The first end 142 is engaged to the first supporting part 122. The second end 144 is engaged to the second supporting part 124. In addition, the mounting base 12 further includes three third supporting parts 126 for mainly supporting the first mounting plates 14 to improve the strength thereof.

As discussed above, according to the preferred embodiment, the razor blade of the razor 1 is the assembly of the first mounting plates 14, the second mounting plates 16, and the blades 18. Moreover, the first mounting plates 14 and the second mounting plates 16 are made of metal, and the structural strength thereof and the anti-fatigue strength thereof are much stronger than that of a single blade and that of a conventional engineering plastic of the prior art. Therefore, without additional members, such as metal wires, the razor 1 of the invention can efficiently clamp the razor blade such that the razor blade will not be easily caught by the beard and depart. In addition, the quantity of the third supporting parts 126 for enhancing the anti-compression strength of the razor blade can be decreased, so the volume occupied by the third supporting part 126 can also be reduced. Therefore, the structure of the mounting base 12 can be further simplified. Furthermore, the blades 18 can be made by pressing. The first mounting plates 14 and the second mounting plates 16 can also be made by pressing a metal into one piece. Coordinating with the structurally simplified mounting base 12, the razor head of the invention can be easily assembled. By use of further automation, the manufacturing cost of the razor head can be lowered substantially, and the yield rate of manufacturing is also increased.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A razor blade, comprising:
a first mounting plate thereon defining a plane;
a second mounting plate connected to the first mounting plate, the second mounting plate having a surface substantially parallel to the plane; and
a blade disposed between the surface and the plane.

2. The razor blade of claim 1, wherein the first mounting plate and the second mounting plate are made in one piece.

3. The razor blade of claim 1, wherein the second mounting plate is connected to the first mounting plate by a spot welding process.

4. The razor blade of claim 1, wherein the second mounting plate tightly presses the blade.

5. The razor blade of claim 1, wherein an angle is formed between the surface and the plane.

6. The razor blade of claim 1, wherein the first mounting plate and the second mounting plate are made of a metal.

7. The razor blade of claim 1, wherein the second mounting plate comprises a notch near a connection with the first mounting plate.

8. A razor head, comprising:
a mounting base;
a first mounting plate engaged to the mounting base, the first mounting plate thereon defining a plane;
a second mounting plate connected to the first mounting plate, the second mounting plate having a surface substantially parallel to the plane; and
a blade disposed between the surface and the plane.

9. The razor head of claim 8, wherein the first mounting plate and the second mounting plate are made in one piece.

10. The razor head of claim 8, wherein the second mounting plate is connected to the first mounting plate by a spot welding process.

11. The razor head of claim 8, wherein the second mounting plate tightly presses the blade.

12. The razor head of claim 8, wherein an angle is formed between the surface and the plane.

13. The razor head of claim 8, wherein the first mounting plate has a first end and a second end, and the first mounting plate is engaged to the mounting base through the first end and the second end.

14. The razor head of claim 13, wherein the mounting base comprises a supporting part, and the first mounting plate is disposed on the supporting part.

15. A razor, comprising:
a mounting base;
a first mounting plate engaged to the mounting base, the first mounting plate thereon defining a plane;
a second mounting plate connected to the first mounting plate, the second mounting plate having a surface substantially parallel to the plane;
a blade disposed between the surface and the plane;
a shell engaged to the mounting base; and
a handle engaged to the shell.

16. The razor of claim 15, wherein the first mounting plate and the second mounting plate are made in one piece.

17. The razor of claim 15, wherein the second mounting plate is connected to the first mounting plate by a spot welding process.

18. The razor of claim 15, wherein the second mounting plate tightly presses the blade.

19. The razor of claim 15, wherein an angle is formed between the surface and the plane.

20. The razor of claim 15, wherein the handle is detachably engaged to the shell.
